(19) United States
(12) Patent Application Publication
(10) Pub. No.: US 2006/0272170 A1
(43) Pub. Date: Dec. 7, 2006

(54) Hand dryer

(76) Inventor: Thomas M. Holmes, North Yorkshire (GB)

Correspondence Address: Arthur G Schaier;Carmody & Torrance, 50 Leavenworth Street, PO Box 1110, Waterbury, CT, 06721-1110, US

(21) Appl. No.: 10/547,723

(22) PCT Filed: Mar. 1, 2004
(86) PCT No.: PCT/IB04/00963

§ 371 Date: May 15, 2006

(30) Foreign Application Priority Data
Mar. 3, 2003 (GB) 0304825.3

(51) Int. Cl. F26B 19/00; F26B 3/34

(52) U.S. Cl. 34/275; 34/90

(57) ABSTRACT

A drying apparatus, and in particular, a hand dryer that comprises a first compartment and a second compartment. The first compartment comprises an inlet for allowing air to enter the first compartment and a germicidal tube mounted in the first compartment for sterilizing air in the first compartment; while the second compartment comprises a heating element for heating sterilized air in the second compartment and a blowing unit for causing sterilized air in the second compartment to rapidly exit the second compartment and out of the hand dryer. A fan is provided for causing sterilized air to leave the first compartment and enter the second compartment. In this way, the sterilized air that exits the second compartment and out of the hand dryer is at least essentially free of airborne microorganisms.

This invention relates generally to hand dryers, and in particular, to a dual-compartment hand dryer that dries ones' hands with air that has been both sterilized and heated.

Hand dryers are well known, and generally consist of a blower unit that directs air that has been heated, most typically by electric heating elements. An outlet nozzle is typically used to direct the heated (i.e. warm) air onto and over the hands that are placed in the moving stream of air exiting the nozzle during a hand drying cycle.

Generally, such commercial and industrial hand dryers dry the hands with non-sterilized air, thereby subjecting the hands to continuous contact with bacteria and other airborne microorganisms. Obviously, in certain industries, such as the medical and food industry, by way of example and not limitation, such a limitation is intolerable, or at the least, very undesirable. Specifically, it is desirable to provide a hand dryer that dries ones hands with sterilized air so as to minimize the risk of transmitted bacteria or the like.

At least one individual has attempted to address this concern, and was awarded a patent on a particular hand dryer construction therefore. Specifically, U.S. Pat. No. 3,667,134 attempts to provide a sterilizing hand dryer to overcome the aforementioned shortcoming in what was, at the time, the state of the art in hand dryers. In particular, U.S. Pat. No. 3,667,134 describes the use of a recirculating cabinet in which a blower draws air from a hand receiving compartment into a bottom cabinet portion, wherein it is subjected to light emitted from a germicidal lamp and heat from a heating element, before the air exits the bottom cabinet portion and reenters the hand receiving compartment via an air duct. It is into this hand-receiving compartment that one sticks his/her hand for drying.

However, further advancements in the art are desirable. For example, one perceived disadvantage in the aforementioned hand drying unit is the inefficient construction to achieve the heating and sterilization of the air. Specifically, the use of a single chamber in which both the air is heated and sterilized has been found to be less than desirable. Secondly, the use of a singular fan upstream (in the direction of airflow) of the heating and sterilizing elements has been found to be less than effective for the needs of commercial and industrial hand dryers as well as for other applications, such as those disclosed herein, due to the apparent lack of sufficient air movement and heating ability. Still further, the aforementioned prior art patent did not recognize, and thus does not take advantage of, the ability to discharge continuous sterilized air into an area of interest, independent of whether the hand dryer is operating in a hand-drying cycle, which is quite apparent from the description of “recirculating” the air.

The present invention overcomes the perceived deficiencies in the prior art as well as provides the objectives and advantages set forth above and below.

### SUMMARY AND OBJECTIVES OF THE INVENTION

Therefore, it is an object and advantage of the present invention to provide an improved hand dryer that dries hands with heated and sterilized air.

It is a further object and advantage of the present invention to provide an improved hand dryer that more efficiently heats and sterilizes the air prior to drying ones hands.

It is a further object and advantage of the present invention to provide an improved hand dryer that provides for a more efficient drying operation than that found in prior sterilization hand dryer constructions.

Another object and advantage of the present invention to provide an improved hand dryer that takes advantage of the ability to continuously discharge sterilized air into an area of interest, independent of whether the hand dryer is operating in a hand drying cycle.

Further objects and advantages of this invention will become more apparent from a consideration of the drawings and ensuing description.

The invention accordingly comprises the features of construction, combination of elements and arrangement of parts that will be exemplified in the disclosure hereinafter set forth, and the scope of the invention will be indicated in the claims.

To overcome the perceived deficiencies in the prior art and to achieve the objects and advantages above and below, the present invention is, generally speaking, directed to a drying apparatus, and in particular, but not limited to, a hand dryer.

In the preferred embodiment, the hand dryer comprises a first compartment and a second compartment, wherein the first compartment has an outlet and the second compartment has an inlet, with the outlet of the first compartment being coupled to the inlet of the second compartment; and a divider for dividing the first compartment from the second compartment. The first compartment comprises an inlet for allowing air to enter the first compartment and a germicidal tube mounted in the first compartment for sterilizing air in the first compartment; while the second compartment comprises a heating element for heating sterilized air in the second compartment and a blowing unit for causing sterilized air in the second compartment to rapidly exit the second compartment and out of the hand dryer. A fan is provided for causing sterilized air to leave the first compartment and enter the second compartment. In this way, the sterilized air that exits the second compartment and out of the hand dryer is at least essentially free of airborne microorganisms.

Particular advantages features of the present invention are that the heating element and the blowing unit are located downstream from the germicidal tube; wherein the heating element heats air that has already been sterilized by the germicidal tube and the blowing unit causes air that has already been sterilized to exit the second compartment. In one particular construction, the blowing unit draws sterilized air out of the second compartment and out of the hand dryer, and in a specific embodiment, the blowing unit is a fan. Additionally, specific features are that the fan draws sterilized air out of the first compartment and into the second compartment, and that the fan can independently cause sterilized air from the first compartment to exit the second compartment and out of the hand dryer, whereby sterilized air that exits the second compartment and out of the hand dryer from the operation of the fan is at least essentially free of airborne microorganisms.

As additional features, the germicidal tube emits UVC light; and a metal chassis houses both the first and second compartments, whereby UVC light is prevented from escaping the hand dryer. Lastly, a grill may be provided intermediate the first and second compartments for preventing foreign objects from being drawn from the first compartment into the second compartment.

The present invention is widely applicable to a range of applications and may be used in a wide range of areas of interest, such as, by example and not limitation, hospitals, doctor's offices, food processing and packaging facilities, restaurants, restrooms, eating areas, and areas where livestock may be present.

### BRIEF DESCRIPTION OF THE DRAWING

The above set forth and other features of the invention are made more apparent in the ensuing Description of the Preferred Embodiments when read in conjunction with the attached Drawing, wherein:

FIG. 1 is a simplified plan view of a hand dryer constructed in accordance with the present invention; and

FIG. 2 is a simplified cross-sectional view of the hand dryer of FIG. 1 taken about lines 2-2.

Identical reference numerals in the figures are intended to indicate like parts, although not every feature in every figure may be called out with a reference numeral.

### DESCRIPTION OF THE PREFERRED EMBODIMENTS

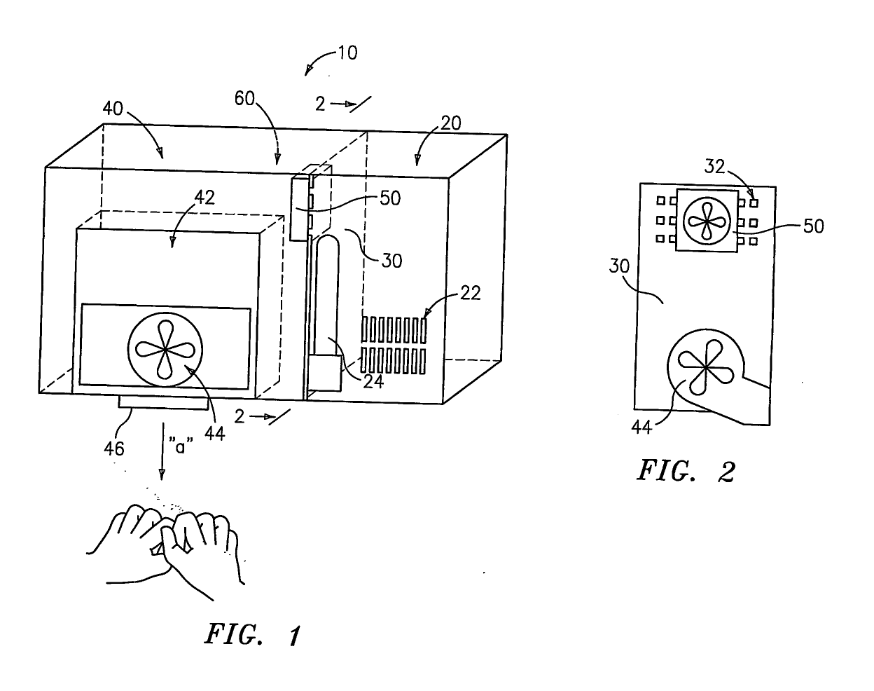

Reference is made to FIGS. 1 and 2, which illustrates a hand dryer, generally indicated at 10, constructed in accordance with the present invention. What follows first is a disclosure of the construction of dryer 10, with the operation and advantages provided thereby to follow thereafter.

Generally speaking, hand dryer 10 is preferably a two compartment apparatus, namely, having a first compartment, generally indicated at 20, and a second compartment, generally indicated at 40. Each compartment is defined by a plurality of walls, as clearly illustrated in the Figures. Most notably is dividing wall 30, which is preferably a common wall that separates or otherwise divides first compartment 20 from second compartment 40.

At this dividing wall 30, it can be seen that first compartment 20 is provided with an air outlet, and may be achieved by a grill, grate, slot(s) or vent(s), and is generally indicated by reference numeral 32 (FIG. 2). As shown in the Figures, this outlet 32 is also seen to function as the air inlet for second compartment 40. However, it should be understood that other modifications are clearly within the scope of this invention, such as having a more defined and/or separated inlet and outlet, such as a channel or duct, the important feature merely being that the outlet of first compartment 20 is coupled to the inlet of second compartment 40 so that air can pass from first compartment 20 to second compartment 40, as disclosed below.

Depending on the construction of the aforementioned inlet and outlet, a separate grill or the like may be provided intermediate the first and second compartments for preventing foreign objects from being drawn from the first compartment into the second compartment.

With the two compartments being adjacent as set forth above, attention will now be turned to the particulars of each compartment.

Specifically, in the preferred embodiment, the first compartment comprises an inlet 22, again such as a grill, grate, slot(s) or vent(s). Inlet 22 may be provided on any of the outer walls (other than wall 30), so as to allow air to enter first compartment 20 from outside dryer 10.

A germicidal tube 24, preferably an 18 W TUV (254 nm UVC) that is commercially available, is mounted in first compartment 20. If possible, it has been found that use of UVC at 253.7 nanometers, if such precision is possible, is desirable. Tube 24 is for sterilizing air in first compartment 20. Here, tube 24 may be mounted on any of the walls of first compartment 20, although in the preferred embodiment, tube 24 is mounted on wall 30. The mounting thereof can be with bolts, screws and/or adhesive, all as would be known in the art.

As constructed, when tube 24 is operational, the UVC light emitted by tube 24 destroys, kills and/or eliminates at least essentially, if not all, the airborne microorganisms in the air contained in first compartment 20.

Turning now briefly to second compartment 40, it preferably comprises a heating element, generally indicated at 42, for heating the air in the second compartment, and a blowing unit, generally indicated at 44, for causing air in second compartment 40 to rapidly exit the second compartment and out of hand dryer 10. Preferably, blowing unit 44 is a fan that draws air out of second compartment 40 and out of hand dryer 10 via an outlet 46, as indicated by arrow “a”. Mounting of heating element 42 and blowing unit 44 in second compartment can also be achieved by bolts, screws or the like, all as would also be known in the art

A fan 50 is provided essentially at the intersection of the inlet of second compartment 40 and the outlet of first compartment 20, for causing sterilized air to leave first compartment 20 and enter second compartment 40. In the preferred embodiment, fan 50 is mounted on wall 30 on the second compartment side of dryer 10. However, this is only exemplary, as fan 50 could satisfactorily be mounted on wall 30 on the first compartment side of wall 30. In its illustrated position, fan 50 functions by drawing sterilized air out of first compartment 20 and into second compartment 40. Additionally, fan 50 acts to draw air from the outside through inlets 22.

Although not specifically shown, a metal cover is preferably provided to cover both the first and second compartments to prevent any UVC light from escaping hand dryer 10. This cover may also be decorative, and be provided to cover the entire dryer and provide for an aesthetically pleasing design. Such a cover would allow for different colors, etc. and make for a more commercially desirable unit. Also, it goes without saying that such a cover would protect users from the electrical components and be yet another layer of protection from the WVC light. Preferably, tamperproof screws or coupling fixings would be provided to secure the cover on the unit.

It should now be clear that the sterilized air that exits second compartment 40 and out of hand dryer 10 is at least essentially, if not fully, free of airborne microorganisms.

That is, in operation, non-sterilized air enters inlet 22 and fills compartment 20. Germicidal tube 24, when in the “on” mode (which is preferably all the time so as to appreciate the advantages more explicitly set forth herein), sterilizes the air in first compartment 20 by the UVC light emitted thereby.

Fan 50, causes sterilized air to leave first compartment 20 and enter second compartment 40. Preferably, fan 50 achieves this by drawing the air out of first compartment 20 when mounted in second compartment 40.

In the preferred embodiment, the hand drying cycle begins when a sensor, such as infrared sensor, senses the presence of hands under and/or near outlet 46 of second compartment 40. This is by way of example, as other means, such as a push button, etc. could be implemented to initiate the beginning of a hand drying cycle, all of which is clearly within the purview of the skilled artisan.

After initiation of the hand drying cycle, the sterilized air, now in second compartment 40 most significantly by way of fan 50, is heated by heating element 42. Blowing unit 44 causes the sterilized air in second compartment 40 to rapidly exit second compartment 40 and out of hand dryer 10 via the path of outlet 46. It should be understood that it is contemplated hereby, and is broadly covered in the claims, that the heating of the sterilized air in compartment 40 can take place before, simultaneous with, or shortly after the air has encountered blowing unit 44. The preference of this construction is one of design choice and the invention should not be considered limited thereby.

In accordance with an advantageous feature not at all described or suggested by U.S. Pat. No. 3,667,134, the present invention recognizes that with germicidal tube 24 in constant operation (i.e. constantly emitting UVC light), the air in first compartment 20 is constantly being sterilized. In this way, even when dryer 10 is not in a hand drying cycle (i.e. heating element 42 and blowing unit 44 are “off”), fan 50 can be independently operational thus causing sterilized air from the first compartment to enter and thereafter exit the second compartment via outlet 46 and out of the hand dryer, whereby this sterilized air that exits hand dryer 10 from the operation of fan 50 is at least essentially, if not fully, free of airborne micro-organisms. That is, although not warmed, this air can be seen to “trickle” out of outlet 46, thus supplementing the advantage of dryer 10 by continually injecting sterilized air into the area of interest in which dryer 10 is located or positioned. This feature is clearly not described or suggested in the aforementioned prior art patent, as it clearly only contemplates the use of recycling air that remains and does not escape the cabinet.

The foregoing disclosure provides for a complete enabling of the present invention, and provides the best mode known to carry out the present invention. However, for completeness, the following additional details are set forth.

The electrical connections to operate the various electrical components of the present invention (namely germicidal tube 24, fan 50, heating element 42 and blowing unit 44) would be well known to someone skilled in the art, and are accomplished by use of a battery source or AC, and in the case of the latter, utilizing a power plug preferably mounted through a rear wall 60 of dryer 10. Independent switches may be used to independently operate the electrical components, or such components may be grouped together; for example, germicidal tube 24 and fan 50 could be electrically connected to always operate together, while heating element 42 and blowing unit 44 could similarly be wired to operate simultaneously. The foregoing configuration would also allow fan 50 to operate independently of heating element 42 and blowing unit 44, thus providing the advantages set forth above.

It will thus be seen that the present invention is both patentably different from and a significant improvement over the cited prior art. Specifically, a hand dryer constructed in accordance with the present invention provides an improved hand dryer that dries hands with heated and sterilized air. Furthermore, the present invention provides an improved hand dryer that more efficiently heats and sterilizes the air prior to drying ones hands. Still further, the present invention provides an improved hand dryer that provides for a more efficiently drying operation than that found in prior sterilization hand dryer constructions. Most significantly, this is achieved by an arrangement in which heating element 42 and blowing unit 44 are placed downstream (i.e. when viewed relative to the path of the air moving from the first compartment to the second compartment) of germicidal tube 24, and in clear patentable distinction to that described in the cited art wherein the blower is placed upstream of the germicidal tube and heating element, and in fact is intentionally separated therefrom, thus preventing a significant air discharging force, thus leading to a more inefficient drying process than that provided by the present invention. Lastly, a drying apparatus constructed in accordance with the present invention takes advantage of the ability to continuously discharge sterilized air into an area of interest, independent of whether the hand dryer is operating in a hand drying cycle, and is also a feature that is clearly deficient in the prior art.

Although described in the context of preferred embodiments, it should be realized that a number of modifications to these teachings may occur to one skilled in the art. Although this disclosure is written in terms of a hand dryer, a general air sterilizing apparatus has been disclosed herein. It should also be understood that the present invention could be used to heat and/or dry other objects, such as towels or the like, and the invention should therefore not be so limiting to hand dryers. Also, the area of interest in which the invention is used is only limited by the imagination of the user, but by way of example and not limitation, hospitals, doctor's offices, food processing and packaging facilities, restaurants, restrooms, eating areas, and areas where livestock may be present, as well as any other place that can appreciate and benefit from the present invention.

While the invention has been particularly shown and described with respect to preferred embodiments thereof, it will be understood by those skilled in the art that changes in form and details may be made therein without departing from the scope and spirit of the invention. Lastly, it should be understood that the phrase “free of airborne microorganisms” (or similar language) should be understood, as clearly disclosed above, to mean that the airborne microorganisms have been destroyed, killed and/or otherwise eliminated, as one skilled in the art would appreciate the effects of the aforementioned UVC effects on such microorganisms.

1. A hand dryer, comprising:
a first compartment and a second compartment, wherein the first compartment has an outlet and the second compartment has an inlet, with the outlet of the first compartment being coupled to the inlet of the second compartment, and a divider for dividing the first compartment from the second compartment;
the first compartment comprising:
an inlet for allowing air to enter the first compartment; and
a germicidal tube mounted in the first compartment for sterilizing air in the first compartment;
the second compartment comprising:
a heating element for heating sterilized air in the second compartment; and
a blowing unit for causing sterilized air in the second compartment to rapidly exit the second compartment and out of the hand dryer; and
a fan, positioned intermediate the germicidal tube and the blowing unit, for causing sterilized air to leave the first compartment and enter the second compartment;
whereby the sterilized air that exits the second compartment and out of the hand dryer is at least essentially free of airborne microorganisms.

2. The hand dryer as claimed in claim 1, wherein the heating element and the blowing unit are located downstream from the germicidal tube;
wherein the heating element heats air that has already been sterilized by the germicidal tube and the blowing unit causes air that has already been sterilized to exit the second compartment.

3. The hand dryer as claimed in claim 1, wherein the heating element and the blowing unit are located downstream from the germicidal tube; and
wherein the blowing unit draws sterilized air out of the second compartment and out of the hand dryer and wherein the heating element heats air that has already been sterilized by the germicidal tube.

4. The hand dryer as claimed in claim 1, wherein the blowing unit draws sterilized air out of the second compartment and out of the hand dryer.

5. The hand dryer as claimed in claim 1, wherein the blowing unit is a fan.

6. The hand dryer as claimed in claim 1, wherein the fan draws sterilized air out of the first compartment and into the second compartment.

7. The hand dryer as claimed in claim 6, wherein the fan independently causes sterilized air from the first compartment to exit the second compartment and out of the hand dryer;
whereby sterilized air that exits the second compartment and out of the hand dryer from the operation of the fan is at least essentially free of airborne microorganisms.

8. The hand dryer as claimed in claim 1, wherein the germicidal tube emits UVC light; and a metal chassis houses both the first and second compartments;
whereby UVC light is prevented from escaping the hand dryer.

9. The hand dryer as claimed in claim 1, including a grill positioned intermediate the first and second compartments for preventing foreign objects from being drawn from the first compartment into the second compartment.

10. A drying apparatus, comprising:
a first compartment and a second compartment, wherein the first compartment has an outlet and the second compartment has an inlet, with the outlet of the first compartment being coupled to the inlet of the second compartment, and a divider for dividing the first compartment from the second compartment;
the first compartment comprising:
an inlet for allowing air to enter the first compartment; and
a germicidal tube mounted in the first compartment for sterilizing air in the first compartment;
the second compartment comprising:
a heating element for heating sterilized air in the second compartment; and
a blowing unit for causing sterilized air in the second compartment to rapidly exit the second compartment and out of the drying apparatus; and
a fan, positioned intermediate the germicidal tube and the blowing unit, for causing sterilized air to leave the first compartment and enter the second compartment;
whereby the sterilized air that exits the second compartment and out of the drying apparatus is at least essentially free of airborne micro-organisms.

11. The drying apparatus as claimed in claim 10, wherein the heating element and the blowing unit are located downstream from the germicidal tube; and
wherein the blowing unit draws sterilized air out of the second compartment and out of the drying apparatus and wherein the heating element heats air that has already been sterilized by the germicidal tube.

12. The drying apparatus as claimed in claim 10, wherein the blowing unit draws sterilized air out of the second compartment and out of the drying apparatus.

13. The drying apparatus as claimed in claim 10, wherein the fan draws sterilized air out of the first compartment and into the second compartment.

14. The drying apparatus as claimed in claim 13, wherein the fan independently causes sterilized air from the first compartment to exit the second compartment and out of the drying apparatus;
whereby sterilized air that exits the second compartment and out of the drying apparatus from the operation of the fan is at least essentially free of airborne microorganisms.

15. A hand dryer, comprising:
a first compartment and a second compartment, wherein the first compartment has an outlet and the second compartment has an inlet, with the outlet of the first compartment being coupled to the inlet of the second compartment, and a divider for dividing the first compartment from the second compartment;
the first compartment comprising an inlet for allowing air to enter the first compartment; and a germicidal tube mounted in the first compartment for sterilizing air in the first compartment;
the second compartment comprising a heating element for heating sterilized air in the second compartment; and a blowing unit for causing sterilized air in the second compartment to rapidly exit the second compartment and out of the hand dryer; wherein the heating element and the blowing unit are located downstream from the germicidal tube and the heating element heats air that has already been sterilized by the germicidal tube and the blowing unit causes air that has already been sterilized to exit the second compartment; and
a fan for causing sterilized air to leave the first compartment and enter the second compartment, wherein the fan and the blowing unit are independently operational so that even when the blowing unit is not operational, the fan is operational;
whereby when the blowing unit is not operational, the fan causes sterilized air to exit the second compartment without the assistance of the blowing unit.

16. (canceled)

17. A hand dryer, comprising:
a first compartment and a second compartment, wherein the first compartment has an outlet and the second compartment has an inlet, with the outlet of the first compartment being coupled to the inlet of the second compartment, and a divider for dividing the first compartment from the second compartment;
the first compartment comprising:
an inlet for allowing air to enter the first compartment; and
a germicidal tube mounted in the first compartment for sterilizing air in the first compartment;
the second compartment comprising:
a heating element for heating sterilized air in the second compartment; and
a blowing unit for causing sterilized air in the second compartment to rapidly exit the second compartment and out of the hand dryer; and
means coupling the outlet of the first compartment to the inlet of the second compartment, said coupling means incorporating a fan for causing sterilized air to be drawn out of the first compartment and into the second compartment;
whereby the sterilized air that exits the second compartment and out of the hand dryer is at least essentially free of airborne microorganisms.

18. The hand dryer as claimed in claim 17, wherein the fan is mounted on said divider at the intersection of the inlet of the second compartment and the outlet of the first compartment.

19. The hand dryer as claimed in claim 18, wherein the fan is mounted on the second compartment side of the divider.

20. The hand dryer as claimed in claim 18, wherein the fan is mounted on the first compartment side of the divider.

21. The hand dryer as claimed in claim 17, wherein the blowing unit is a fan.

22. A drying apparatus, comprising:
a first compartment and a second compartment, wherein the first compartment has an outlet and the second compartment has an inlet, with the outlet of the first compartment being coupled to the inlet of the second compartment, and a divider for dividing the first compartment from the second compartment;
the first compartment comprising:
an inlet for allowing air to enter the first compartment; and
a germicidal tube mounted in the first compartment for sterilizing air in the first compartment;
the second compartment comprising:
a heating element for heating sterilized air in the second compartment; and
a blowing unit for causing sterilized air in the second compartment to rapidly exit the second compartment and out of the drying apparatus; and
means coupling the outlet of the first compartment to the inlet of the second compartment, said coupling means incorporating a fan for causing sterilized air to be drawn out of the first compartment and into the second compartment;
whereby the sterilized air that exits the second compartment and out of the drying apparatus is at least essentially free of airborne microorganisms.

23. A drying apparatus, comprising:
a first compartment and a second compartment, wherein the first compartment has an outlet and the second compartment has an inlet, with the outlet of the first compartment being coupled to the inlet of the second compartment, and a divider for dividing the first compartment from the second compartment;
the first compartment comprising an inlet for allowing air to enter the first compartment; and a germicidal tube mounted in the first compartment for sterilizing air in the first compartment;
the second compartment comprising a heating element for heating sterilized air in the second compartment; and a blowing unit for causing sterilized air in the second compartment to rapidly exit the second compartment and out of the drying apparatus; wherein the heating element and the blowing unit are located downstream from the germicidal tube and the heating element heats air that has already been sterilized by the germicidal tube and the blowing unit causes air that has already been sterilized to exit the second compartment; and
means coupling the outlet of the first compartment to the inlet of the second compartment, said coupling means incorporating a fan for causing sterilized air to be drawn out of the first compartment and into the second compartment, wherein the fan and the blowing unit are independently operational so that even when the blowing unit is not operational, the fan is operational;
whereby when the blowing unit is not operational, the fan causes sterilized air to exit the second compartment without the assistance of the blowing unit.

24. The drying apparatus as claimed in claim 23, wherein the drying apparatus is a hand dryer.
